(19) United States
(12) Patent Application Publication
(10) Pub. No.: US 2026/0065683 A1
(43) Pub. Date: Mar. 5, 2026

(54) SYSTEM AND METHOD FOR OCCUPANCY MONITORING ON SHORES

(71) Applicant: Nuvis Technologies Inc., Mississauga (CA)

(72) Inventors: Anton Goma Huguet, Cervera (ES); Damodar Arapakota, Mississauga (CA)

(73) Assignee: Nuvis Technologies Inc., Mississauga (CA)

(21) Appl. No.: 19/035,181

(22) Filed: Jan. 23, 2025

Related U.S. Application Data
(60) Provisional application No. 63/688,950, filed on Aug. 30, 2024.

(51) Int. Cl. G06V 20/52; G06V 10/10; G06V 10/26; G06V 20/58; G06V 40/20; H04N 23/68

(52) U.S. Cl. CPC G06V 20/53; G06V 10/16; G06V 10/26; G06V 20/58; G06V 40/20; H04N 23/682

(57) ABSTRACT

The various embodiments herein provide a system and method for occupancy monitoring on shores, dynamically using a mobile camera system mounted on a mobile platform. The system utilizes advanced imaging technologies, differential GNSS for precise geo-tagging, and an AI-driven analysis framework to enhance the accuracy and reliability of occupancy data. The mobile nature of the system enables comprehensive coverage and real-time adaptability to changing conditions, significantly reducing resource utilization over traditional static camera methods. The system's modular design ensures scalability and flexibility, making it adaptable to various shoreline environments. This comprehensive approach not only increases the efficiency of monitoring practices but also supports more informed decision-making for beach management authorities.

### CROSS-REFERENCE TO RELATED APPLICATIONS

The embodiments herein claim the priority of the U.S. Provisional Patent Application filed on Aug. 30, 2024, with the no. 63/688,950 and titled, “SYSTEM AND METHOD FOR OCCUPANCY MONITORING ON SHORES”, the contents of which are incorporated herein by the way of reference.

### BACKGROUND

### Description of the Related Art

The embodiments herein are generally related to monitoring technologies. The embodiments herein are particularly related to monitoring systems used in large open areas. The embodiments herein are more particularly related to a system and method for occupancy monitoring on shores.

### Description of the Related Art

Traditional methods of occupancy monitoring on beaches predominantly utilize static camera systems strategically placed along the shore. These methods, however, are fraught with several limitations. Conventional beach monitoring systems are often expensive to install and maintain, requiring multiple cameras to cover extensive areas. This not only increases the cost but also complicates the logistics of system deployment and maintenance. These systems also struggle with the challenge of double-counting individuals due to overlapping fields of view without a reliable means to reconcile duplicate counts.

Furthermore, fixed monitoring systems lack the flexibility to adapt to changing crowd locations in real-time. The static nature of these systems means they cannot reposition in response to dynamic beach activities or shifting crowd concentrations, thus limiting their effectiveness in real-time crowd management and safety enforcement.

Therefore, there exists a need for a system and method for occupancy monitoring on shores that provides dynamic, accurate, and cost-effective monitoring of shorelines that adapts in real-time to varying conditions, provide comprehensive coverage without blind spots, and handle data with greater accuracy to prevent errors such as multiple-counting.

The abovementioned shortcomings, disadvantages and problems are addressed herein, which will be understood by reading and studying the following specification.

### OBJECT OF THE EMBODIMENTS HEREIN

The primary object of the embodiments herein is to provide a system and method for occupancy monitoring on shores.

Another object of the embodiments herein is to provide a system and method for dynamically monitoring occupancy on shores using a camera system mounted on a mobile platform like an all-terrain vehicle (ATV) or a drone.

Yet another object of the embodiments herein is to enhance the accuracy and reliability of occupancy data through the integration of advanced imaging and artificial intelligence.

Yet another object of the embodiments herein is to eliminate the logistical complexities and reduce the costs associated with the deployment and maintenance of multiple static cameras.

Yet another object of the embodiments herein is to provide real-time feedback and adapt the monitoring process based on live data from the field, thereby enhancing responsiveness and operational efficiency.

Yet another object of the embodiments herein is to ensure comprehensive coverage of monitored areas, eliminating blind spots using a mobile monitoring system that dynamically adjusts its path.

Yet another object of the embodiments herein is to increase operational flexibility and responsiveness in managing shore occupancy, allowing for adjustments in monitoring strategies based on real-time environmental and crowd conditions.

Yet another object of the embodiments herein is to incorporate a modular system design that allows for easy scalability and adaptability to different shoreline environments and conditions.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for occupancy monitoring on shores.

According to one embodiment herein, a system is provided for occupancy monitoring on shores. The system comprises: a high resolution imaging module capturing images at regular intervals along a pre-determined route and providing the raw visual data needed for people counting and beach occupancy analysis; an image stabilization module maintaining the steadiness of the imaging module during the movement of the mobile platform using a plurality of methods including camera stabilizer, gimbal, optical stabilization and electronic image stabilization ensuring high quality image capture by reducing motion blur and distortion; a mobile platform providing a dynamic base for facilitating the movement of system modules across the shoreline for imaging; a differential GNSS module providing accurate location data for precise positioning of the mobile platform, enhancing the accuracy of geo-tagging each captured image, enabling accurate mapping and analysis of the beach occupancy; a mobility control module controlling the operational parameters of the mobile platform including speed, route adjustments and camera pointing using inputs from differential GNSS module and control hub; an image processing module processing the images to provide adjustments for lighting, color, dynamic ranges and panoramic stitching of overlapping images and preparing data for accurate interpretation by the AI module; an AI module providing accurate counts of individuals managing data from overlapping image fields without multiple-counting, and providing a comprehensive occupancy monitoring using AI algorithms; a communication module securely transmitting and receiving data between the mobile platform and control hub; a data storage module managing the storage of all captured and processed data, including images, count data, and system logs, providing a centralized repository for data that supports historical data analysis, system audits, and backup for recovery and reporting purposes; and a User Interface module providing a user-friendly interface for system operators and beach management authorities, providing access to real-time data, historical analytics, and system controls enabling easy interaction with the system for monitoring, analysis, and decision-making, enhancing user engagement and operational efficiency. The Mobile Platform Module serving as the dynamic base for Imaging Module, Image Stabilization, Differential GNSS receiver and the communication module, configured on an all-terrain vehicle (ATV) or a drone, selected based on the specific needs and terrain of the shoreline being monitored, and wherein the mobile platform facilitates the movement and operation of the mounted systems across the shoreline, allowing for dynamic, real-time monitoring, avoiding obstacles and reaching areas that are otherwise inaccessible to static monitoring setups. The differential GNSS module further comprising a Base Station module and a rover module, and wherein the base station module installed at a pre-surveyed point at the control hub continuously receiving signals from a plurality of GNSS satellites including GPS, Galileo, Beidou and NavIC, calculating differential corrections for the GNSS signals and transmitting the corrections via secured wireless communication channels to the rover module using standard protocols, enhancing the accuracy of GNSS data received by the rover; and wherein the rover module mounted on the mobile platform receiving both the standard GNSS signals and the correction signals from the Base Station module, computes a corrected, precise position of the mobile platform in real time for accurate geo-tagging of the captured images and for maintaining the precise trajectory and coverage area as dictated by the system's monitoring algorithms. The image processing module is designed to handle and refine the visual data captured by the imaging module using algorithms to enhance image quality including adjustments such as contrast enhancement, brightness correction, and noise reduction, stitching overlapping images to create panoramic views ensuring seamless transitions between consecutive images, detecting and identifying specific features within the images, segmenting the images into manageable areas for detailed analysis and tagging each segment with relevant metadata such as time and location and prepare the data for further analysis by the AI module. The AI module is configured with AI algorithms including computer vision algorithms and deep neural networks and wherein the AI module identifies people from other objects in the images, counts and tracks their movements across multiple images, avoids multiple-counting and provides crowd density and movement patterns for efficient crowd management. The Mobility Control Module orchestrating the movement and operational parameters of the mobile platform, using real-time data inputs from the Differential GNSS Module to navigate the vehicle accurately along predefined routes and adjusts these routes dynamically based on real-time feedback from the AI and Image Processing Modules and wherein the Mobility Control Module maintains optimal speed and trajectory of the mobile platform for effective image capture, adjusting for obstacles, crowd density, and other environmental factors, and wherein the mobility control module is configured with advanced control algorithms enhancing system's adaptive capabilities, maximizing the coverage and efficiency of the monitoring operations, ensuring comprehensive and flexible response to varying shoreline conditions. The Control Hub serving as the central command center for the shore occupancy monitoring system, orchestrating the integration and management of all operational data and system modules and wherein the control hub continuously receives processed data from the mobile platform, monitors the shoreline conditions, make informed decisions, and dynamically adjust operational parameters such as the routes and speeds of the mobile platform, and wherein the Control Hub is configured to enable visualization of data, generation of reports, and issuance of commands back to the system components ensuring that the system operates efficiently, adapting in real-time to changes in beach conditions, and providing beach management authorities with actionable insights for crowd management and safety measures.

According to one embodiment herein, a method is provided for occupancy monitoring on shores. The method includes: Initial System Setup and Calibration of the modules on the mobile platform including installing the high-resolution imaging module, integrating the differential GNSS module for precise positioning, and configuring the AI module for image analysis ensuring all components operate in harmony and with optimal settings for the specific environment of the shoreline to be monitored; Route Planning and Deployment wherein a detailed route plan is created based on the geographical layout of the shore, allowing for overlapping fields of view between consecutive images, eliminating blind spots and ensuring that the entire area is adequately covered; Image Capture and Geo-tagging wherein the Imaging Module captures images at regular intervals as the mobile platform moves and instantly geo-tags with precise location data provided by the Differential GNSS Module, ensuring that every image is accurately mapped to its specific location on the shore; Real-time Image Analysis wherein the images are processed by the AI Module using advanced computer vision algorithms to analyze each image for the presence of individuals, count them accurately, and manage overlaps in fields of view to prevent double-counting; Data Compilation and Transmission wherein the data, including people counts and associated geo-tags, is compiled into a coherent dataset, encrypted and transmitted securely to the Control Hub using the communication module, ensuring the integrity and security of the sensitive information; Real-time Monitoring and Adaptive Adjustments wherein the Control Hub monitors the transmitted data and provides real-time feedback to the system on the mobile platform, based on which adjustments are made dynamically to the platform's route, the camera's capture intervals, or other operational parameters to optimize coverage and data accuracy, adapting to changes in beach occupancy and environmental conditions; Data Analysis and Reporting wherein, the data is further analyzed in the control hub to generate comprehensive reports on beach occupancy, identifying trends, and providing actionable insights enabling effective crowd management, resource allocation, and safety measures implementation by beach management authorities; and Continuous Operation and feedback wherein the system is provides continuous monitoring throughout its deployment, and providing feedback for continuous improvements and adjustments based on real-time data analysis and changing conditions on the shore. The method for Route Planning and Deployment begins with a detailed analysis of the shoreline's geography to map potential routes, optimized for comprehensive coverage and efficiency and wherein the method meticulously integrates the planning of imaging intervals with route mapping to optimize visual coverage and data accuracy and wherein the method identifies key shoreline areas for slight overlaps in camera views, accommodating the mobile platform's speed and crowd dynamics. The method for Real-time Image Analysis includes processing the captured and geo-tagged images using computer vision and AI algorithms analyzing each image for the presence of individuals, count them accurately, and manage overlaps in fields of view in panoramically stitched images preventing multiple counting and wherein the method efficiently handles variations in crowd density and environmental conditions.

According to one embodiment herein, a system is provided for occupancy monitoring on shores. The system comprises: a High-Resolution Imaging Module configured to capture images at regular intervals; a Image Stabilization Module configured to maintain image steadiness during platform movement; a Mobile Platform providing a dynamic base for hosting system components and facilitating movement across a shoreline; a Differential GNSS Module; a Mobility Control Module configured to control the operational parameters of the mobile platform, including speed, route adjustments, and obstacle avoidance; a Image Processing Module configured to enhance image quality, stitch overlapping images, and segment images for analysis; a AI Module configured to analyze images using computer vision algorithms to count individuals and track their movements, avoiding multiple counting; a Communication Module for secure transmission and reception of data between the mobile platform and a control hub; a Data Storage Module configured to manage and store all captured and processed data, including system logs and analytics; a User Interface Module providing real-time access to data, system controls, and historical analytics for monitoring and decision-making; and a Control Hub serving as a central command unit for integrating and managing system operations and dynamically adjusting monitoring parameters.

According to one embodiment herein, the High-Resolution Imaging Module captures high-quality images with adjustments for lighting, color, and dynamic range to provide clarity in varying environmental conditions.

According to one embodiment herein, the Image Stabilization Module utilizes a combination of optical stabilization, electronic stabilization, and gimbal technology to minimize motion blur caused by platform movement.

According to one embodiment herein, the Mobile Platform is an all-terrain vehicle (ATV) or drone, enabling the system to navigate diverse terrains and dynamically adjust its trajectory based on real-time conditions.

According to one embodiment herein, the Differential GNSS Module comprises a base station to compute differential corrections and a rover module to apply the computed corrections for real-time geo-tagging and route optimization.

According to one embodiment herein, the Mobility Control Module dynamically adjusts platform speed and route based on a plurality of inputs, thereby enabling optimal imaging coverage and obstacle avoidance.

According to one embodiment herein, the Image Processing Module stitches overlapping images to form a continuous view of the shoreline and tags image segments with metadata including time and location.

According to one embodiment herein, the AI Module is configured to distinguish individuals from objects, to track movements across multiple images, and to compute crowd density to prevent double-counting and improve monitoring accuracy.

According to one embodiment herein, the Communication Module provides secure data transmission using encryption protocols and real-time feedback between the mobile platform and the control hub, and wherein, the Data Storage Module maintains a centralized repository for captured images, processed data, and system logs, supporting historical analytics and audits, and wherein, the User Interface Module enables real-time interaction for providing visualized data, analytics, and actionable insights.

According to one embodiment herein, the Control Hub integrates real-time data from all modules, dynamically adjusts operational parameters, and generates detailed reports for crowd management and safety enforcement.

According to one embodiment herein, a method is provided for occupancy monitoring on shores, the method comprising: initial system setup and calibration, wherein the modules are installed and configured on the mobile platform; route planning and deployment, wherein a pre-determined route is mapped to ensure comprehensive coverage and eliminate blind spots; image capturing and geo-tagging, wherein the imaging module captures images and tags them with precise location data from the Differential GNSS Module; real-time image stitching and analysis, wherein the Image Processing Module enhances image quality and stitches images for panoramic views; data compilation and transmission, wherein the processed data is compiled and securely transmitted to the Control Hub; real-time monitoring and adaptive adjustments, wherein the Control Hub adjusts monitoring parameters dynamically based on real-time data; data analysis and reporting, wherein insights are generated for crowd management and safety measures; and continuous operation and feedback, wherein the system provides ongoing monitoring and adjusts based on environmental and occupancy changes.

According to one embodiment herein, the initial system setup and calibration involves integrating the Imaging Module, AI Module, and Differential GNSS Module to ensure precise and synchronized operation.

According to one embodiment herein, the route planning step utilizes input from the Differential GNSS Module and considers overlapping fields of view to maximize coverage.

According to one embodiment herein, the image capturing step uses the Image Stabilization Module to ensure clarity and the Differential GNSS Module for accurate geo-tagging, and wherein, the stitching and analysis step combines panoramic stitching by the Image Processing Module and individual identification by the AI Module.

According to one embodiment herein, the data compilation step encrypts data before transmission via the Communication Module to maintain data integrity, and wherein, the real-time monitoring step uses the Control Hub to dynamically adjust the Mobility Control Module and camera capture intervals.

According to one embodiment herein, the analysis step utilizes data stored in the Data Storage Module to generate detailed occupancy trends and insights, and wherein, the feedback loop integrates real-time adjustments from the Control Hub with operational data from the Mobility Control Module and AI Module.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the overall architecture of the system for occupancy monitoring on shores, according to one embodiment herein.

FIG. 2 illustrates the method for occupancy monitoring on shores, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system and method for occupancy monitoring on shores.

According to one embodiment herein, a system is provided for occupancy monitoring on shores. The system comprises: a high resolution imaging module capturing images at regular intervals along a pre-determined route and providing the raw visual data needed for people counting and beach occupancy analysis; an image stabilization module maintaining the steadiness of the imaging module during the movement of the mobile platform using a plurality of methods including camera stabilizer, gimbal, optical stabilization and electronic image stabilization ensuring high quality image capture by reducing motion blur and distortion; a mobile platform providing a dynamic base for facilitating the movement of system modules across the shoreline for imaging; a differential GNSS module providing accurate location data for precise positioning of the mobile platform, enhancing the accuracy of geo-tagging each captured image, enabling accurate mapping and analysis of the beach occupancy; a mobility control module controlling the operational parameters of the mobile platform including speed, route adjustments and camera pointing using inputs from differential GNSS module and control hub; an image processing module processing the images to provide adjustments for lighting, color, dynamic ranges and panoramic stitching of overlapping images and preparing data for accurate interpretation by the AI module; an AI module providing accurate counts of individuals managing data from overlapping image fields without multiple-counting, and providing a comprehensive occupancy monitoring using AI algorithms; a communication module securely transmitting and receiving data between the mobile platform and control hub; a data storage module managing the storage of all captured and processed data, including images, count data, and system logs, providing a centralized repository for data that supports historical data analysis, system audits, and backup for recovery and reporting purposes; and a User Interface module providing a user-friendly interface for system operators and beach management authorities, providing access to real-time data, historical analytics, and system controls enabling easy interaction with the system for monitoring, analysis, and decision-making, enhancing user engagement and operational efficiency.

According to one embodiment herein, the Mobile Platform Module serves as the dynamic base for Imaging Module, Image Stabilization, Differential GNSS receiver and the communication module, configured on an all-terrain vehicle (ATV) or a drone, selected based on the specific needs and terrain of the shoreline being monitored, and wherein the mobile platform facilitates the movement and operation of the mounted systems across the shoreline, allowing for dynamic, real-time monitoring, avoiding obstacles and reaching areas that are otherwise inaccessible to static monitoring setups.

According to one embodiment herein, the differential GNSS module comprises a Base Station module and a rover module, and wherein the base station module installed at a pre-surveyed point at the control hub continuously receiving signals from a plurality of GNSS satellites including GPS, Galileo, Beidou and NavIC, calculating differential corrections for the GNSS signals and transmitting the corrections via secured wireless communication channels to the rover module using standard protocols like RTCM (Radio Technical Commission for Maritime Services), enhancing the accuracy of GNSS data received by the rover; and wherein the rover module mounted on the mobile platform receiving both the standard GNSS signals and the correction signals from the Base Station module, computes a corrected, precise position of the mobile platform in real time for accurate geo-tagging of the captured images and for maintaining the precise trajectory and coverage area as dictated by the system's monitoring algorithms.

According to one embodiment herein, the image processing module is designed to handle and refine the visual data captured by the imaging module using algorithms to enhance image quality including adjustments such as contrast enhancement, brightness correction, and noise reduction, stitching overlapping images to create panoramic views ensuring seamless transitions between consecutive images, detecting and identifying specific features within the images, segmenting the images into manageable areas for detailed analysis and tagging each segment with relevant metadata such as time and location and prepare the data for further analysis by the AI module.

According to one embodiment herein, the AI module is configured with AI algorithms including computer vision algorithms and deep neural networks and wherein the AI module identifies people from other objects in the images, counts and tracks their movements across multiple images, avoids multiple-counting and provides crowd density and movement patterns for efficient crowd management.

According to one embodiment herein, the Mobility Control Module orchestrates the movement and operational parameters of the mobile platform, using real-time data inputs from the Differential GNSS Module to navigate the vehicle accurately along predefined routes and adjusts these routes dynamically based on real-time feedback from the AI and Image Processing Modules and wherein the Mobility Control Module maintains optimal speed and trajectory of the mobile platform for effective image capture, adjusting for obstacles, crowd density, and other environmental factors, and wherein the mobility control module is configured with advanced control algorithms enhancing system's adaptive capabilities, maximizing the coverage and efficiency of the monitoring operations, ensuring comprehensive and flexible response to varying shoreline conditions.

According to one embodiment herein, the Control Hub serves as the central command center for the shore occupancy monitoring system, orchestrating the integration and management of all operational data and system modules and wherein the control hub continuously receives processed data from the mobile platform, monitors the shoreline conditions, make informed decisions, and dynamically adjust operational parameters such as the routes and speeds of the mobile platform, and wherein the Control Hub is configured to enable visualization of data, generation of reports, and issuance of commands back to the system components ensuring that the system operates efficiently, adapting in real-time to changes in beach conditions, and providing beach management authorities with actionable insights for crowd management and safety measures.

According to one embodiment herein, a method is provided for occupancy monitoring on shores. The method includes: Initial System Setup and Calibration of the modules on the mobile platform including installing the high-resolution imaging module, integrating the differential GNSS module for precise positioning, and configuring the AI module for image analysis ensuring all components operate in harmony and with optimal settings for the specific environment of the shoreline to be monitored; Route Planning and Deployment wherein a detailed route plan is created based on the geographical layout of the shore, allowing for overlapping fields of view between consecutive images, eliminating blind spots and ensuring that the entire area is adequately covered; Image Capture and Geo-tagging wherein the Imaging Module captures images at regular intervals as the mobile platform moves and instantly geo-tags with precise location data provided by the Differential GNSS Module, ensuring that every image is accurately mapped to its specific location on the shore; Real-time Image Analysis wherein the images are processed by the AI Module using advanced computer vision algorithms to analyze each image for the presence of individuals, count them accurately, and manage overlaps in fields of view to prevent double-counting; Data Compilation and Transmission wherein the data, including people counts and associated geo-tags, is compiled into a coherent dataset, encrypted and transmitted securely to the Control Hub using the communication module, ensuring the integrity and security of the sensitive information; Real-time Monitoring and Adaptive Adjustments wherein the Control Hub monitors the transmitted data and provides real-time feedback to the system on the mobile platform, based on which adjustments are made dynamically to the platform's route, the camera's capture intervals, or other operational parameters to optimize coverage and data accuracy, adapting to changes in beach occupancy and environmental conditions; Data Analysis and Reporting wherein, the data is further analyzed in the control hub to generate comprehensive reports on beach occupancy, identifying trends, and providing actionable insights enabling effective crowd management, resource allocation, and safety measures implementation by beach management authorities; and Continuous Operation and feedback wherein the system is provides continuous monitoring throughout its deployment, and providing feedback for continuous improvements and adjustments based on real-time data analysis and changing conditions on the shore.

According to one embodiment herein, the method for Route Planning and Deployment begins with a detailed analysis of the shoreline's geography to map potential routes, optimized for comprehensive coverage and efficiency and wherein the method meticulously integrates the planning of imaging intervals with route mapping to optimize visual coverage and data accuracy and wherein the method identifies key shoreline areas for slight overlaps in camera views, accommodating the mobile platform's speed and crowd dynamics.

According to one embodiment herein, the method for Real-time Image Analysis includes processing the captured and geo-tagged images using computer vision and AI algorithms analyzing each image for the presence of individuals, count them accurately, and manage overlaps in fields of view in panoramically stitched images preventing multiple counting and wherein the method efficiently handles variations in crowd density and environmental conditions.

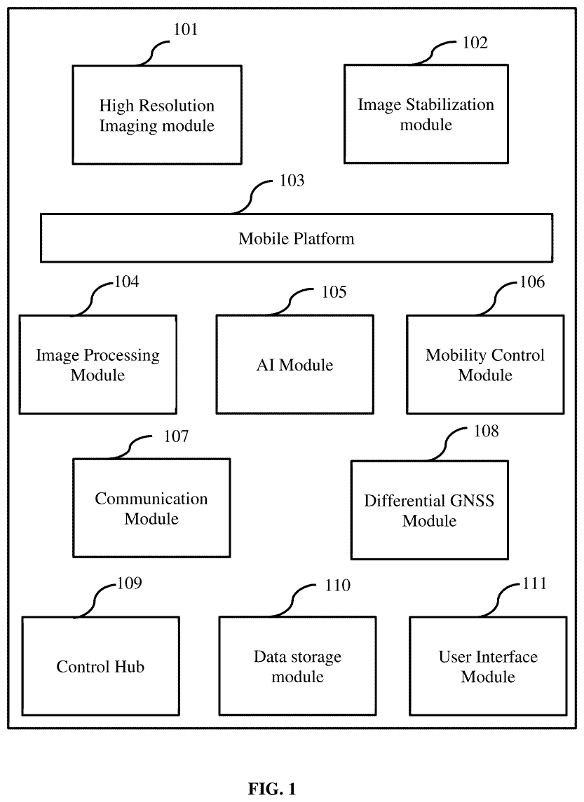

FIG. 1 illustrates the overall architecture of the system for occupancy monitoring on shores, according to one embodiment herein. The system comprises: High Resolution Imaging Module 101; Image Stabilization Module 102; Mobile Platform 103; Image Processing Module 104; AI Module 105; Mobility Control Module 106; Communication Module 107; Differential GNSS Module 108; Control Hub 109; Data Storage Module 110; and User Interface Module 111

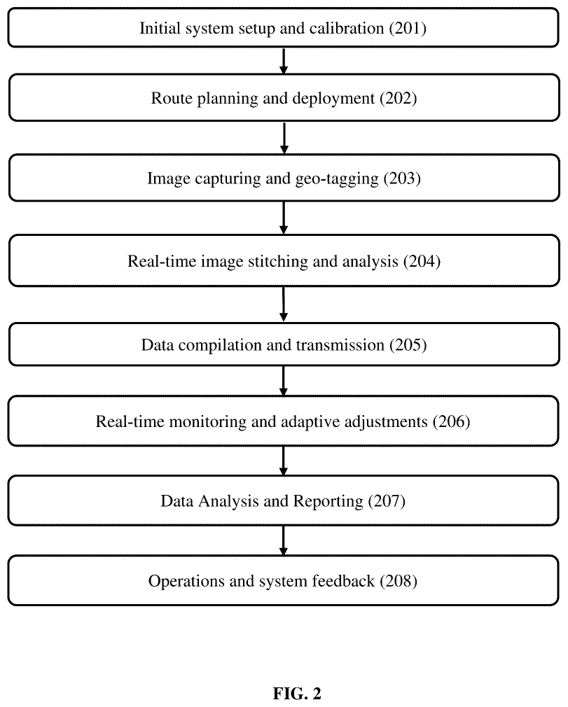

FIG. 2 illustrates the method for occupancy monitoring on shores, according to one embodiment herein. The method includes: Initial System Setup and Calibration (201); Route Planning and Deployment (202); Image Capturing and Geo-tagging (203); Real-time Image Stitching and Analysis (204); Data Compilation and Transmission (205); Real-time Monitoring and Adaptive Adjustments (206); Data Analysis and Reporting (207); and Operations and System Feedback (208).

The various embodiments herein provide system and method for occupancy monitoring on shores offering several distinct advantages over conventional traditional methods by utilizing a mobile camera mounted on a mobile platform enabling dynamic and real-time monitoring. This approach enhances accuracy and reduces duplications through AI-driven image analysis and provides comprehensive coverage. The system's mobility reduces the logistical complexities and costs associated with static cameras, making it cost-effective and easy to maintain. Additionally, its scalable and flexible design allows adaptation to various beach sizes and conditions, improving decision-making and resource allocation for beach management authorities. The real-time data processing and feedback capabilities also enable effective crowd management and safety measures, ensuring enhanced safety for beachgoers.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for occupancy monitoring on shores, the system comprising:
High-Resolution Imaging Module configured to capture images at regular intervals;
Image Stabilization Module configured to maintain image steadiness during platform movement;
Mobile Platform providing a dynamic base for hosting system components and facilitating movement across a shoreline;
Differential GNSS Module;
Mobility Control Module configured to control the operational parameters of the mobile platform, including speed, route adjustments, and obstacle avoidance;
Image Processing Module configured to enhance image quality, stitch overlapping images, and segment images for analysis;
AI Module configured to analyze images using computer vision algorithms to count individuals and track their movements, avoiding multiple counting;
Communication Module for secure transmission and reception of data between the mobile platform and a control hub;
Data Storage Module configured to manage and store all captured and processed data, including system logs and analytics;
User Interface Module providing real-time access to data, system controls, and historical analytics for monitoring and decision-making; and
Control Hub serving as a central command unit for integrating and managing system operations and dynamically adjusting monitoring parameters.

2. The system according to claim 1, wherein the High-Resolution Imaging Module captures high-quality images with adjustments for lighting, color, and dynamic range to provide clarity in varying environmental conditions.

3. The system according to claim 1, wherein the Image Stabilization Module utilizes a combination of optical stabilization, electronic stabilization, and gimbal technology to minimize motion blur caused by platform movement.

4. The system according to claim 1, wherein the Mobile Platform is an all-terrain vehicle (ATV) or drone, enabling the system to navigate diverse terrains and dynamically adjust its trajectory based on real-time conditions.

5. The system according to claim 1, wherein the Differential GNSS Module comprises a base station to compute differential corrections and a rover module to apply the computed corrections for real-time geo-tagging and route optimization.

6. The system according to claim 1, wherein the Mobility Control Module dynamically adjusts platform speed and route based on a plurality of inputs, thereby enabling optimal imaging coverage and obstacle avoidance.

7. The system according to claim 1, wherein the Image Processing Module stitches overlapping images to form a continuous view of the shoreline and tags image segments with metadata including time and location.

8. The system according to claim 1, wherein the AI Module is configured to distinguish individuals from objects, to track movements across multiple images, and to compute crowd density to prevent double-counting and improve monitoring accuracy.

9. The system of claim 1, wherein the Communication Module provides secure data transmission using encryption protocols and real-time feedback between the mobile platform and the control hub, and wherein, the Data Storage Module maintains a centralized repository for captured images, processed data, and system logs, supporting historical analytics and audits, and wherein, the User Interface Module enables real-time interaction for providing visualized data, analytics, and actionable insights.

10. The system of claim 1, wherein the Control Hub integrates real-time data from all modules, dynamically adjusts operational parameters, and generates detailed reports for crowd management and safety enforcement.

11. A method for occupancy monitoring on shores, comprising:
initial system setup and calibration, wherein the modules are installed and configured on the mobile platform;
route planning and deployment, wherein a pre-determined route is mapped to ensure comprehensive coverage and eliminate blind spots;
image capturing and geo-tagging, wherein the imaging module captures images and tags them with precise location data from the Differential GNSS Module;
real-time image stitching and analysis, wherein the Image Processing Module enhances image quality and stitches images for panoramic views;
data compilation and transmission, wherein the processed data is compiled and securely transmitted to the Control Hub;
real-time monitoring and adaptive adjustments, wherein the Control Hub adjusts monitoring parameters dynamically based on real-time data;
data analysis and reporting, wherein insights are generated for crowd management and safety measures; and
continuous operation and feedback, wherein the system provides ongoing monitoring and adjusts based on environmental and occupancy changes.

12. The method according to claim 11, wherein the initial system setup and calibration involves integrating the Imaging Module, AI Module, and Differential GNSS Module to ensure precise and synchronized operation.

13. The method according to claim 11, wherein the route planning step utilizes input from the Differential GNSS Module and considers overlapping fields of view to maximize coverage.

14. The method according to claim 11, wherein the image capturing step uses the Image Stabilization Module to ensure clarity and the Differential GNSS Module for accurate geo-tagging, and wherein, the stitching and analysis step combines panoramic stitching by the Image Processing Module and individual identification by the AI Module.

15. The method according to claim 11, wherein the data compilation step encrypts data before transmission via the Communication Module to maintain data integrity, and wherein, the real-time monitoring step uses the Control Hub to dynamically adjust the Mobility Control Module and camera capture intervals.

16. The method according to claim 11, wherein the analysis step utilizes data stored in the Data Storage Module to generate detailed occupancy trends and insights, and wherein, the feedback loop integrates real-time adjustments from the Control Hub with operational data from the Mobility Control Module and AI Module.
